(19) United States
(12) Patent Application Publication
(10) Pub. No.: US 2025/0118090 A1
(43) Pub. Date: Apr. 10, 2025

(54) ESTIMATING LANE LINES

(71) Applicant: Toyota Jidosha Kabushiki Kaisha, Toyota-shi Aichi-ken (JP)

(72) Inventor: Alexander Christoph Schaefer, Fremont, CA (US)

(21) Appl. No.: 18/481,480

(22) Filed: Oct. 5, 2023

(51) Int. Cl. G06V 20/56; B60W 60/00; G01C 21/00

(52) U.S. Cl. CPC G06V 20/588; B60W 60/001; G01C 21/3815; G01C 21/3841; B60W 2556/40

(57) ABSTRACT

Systems, methods, and other embodiments described herein relate to improving the estimation of lane lines along a roadway. In one embodiment, a method includes acquiring sensor data about a roadway. The sensor data includes at least frames and associated point detections about a lane line associated with the roadway. The method includes identifying a selected point and nearby points of the point detections. The method includes projecting lines from the nearby points to an orthogonal line extending from the selected point to define projection points. The method includes estimating a line point of the lane line according to the projection points. The method includes generating an estimated line for the lane line using the line point and other line points.

### TECHNICAL FIELD

The subject matter described herein relates, in general, to improving the estimation of lane lines and, more particularly, to applying a heuristic to key point detections from sensor data to derive lane lines.

### BACKGROUND

Vehicles may be equipped with sensors that facilitate perceiving aspects of a surrounding environment. For example, a vehicle may be equipped with one or more cameras, location sensors, and so on to provide information about the vehicle and the surrounding environment. This sensor data can be useful in various circumstances for mapping roadways at a level of the lane according to inferences about the path traveled by the vehicle. That is, trace data can include a path of the vehicle along a roadway depicted by periodic identifications of a location (e.g., GPS location). However, accurately identifying lane lines from this information can be complex. That is, the acquired data generally includes separate point detections of the lanes that may vary according to a detection error. Thus, explicitly connecting the lane lines can result in erratic representations of lanes, which may cause difficulties when the lanes are used by downstream processes to define the lanes. Moreover, keypoint detections are usually not ordered. Even if estimating a line based on the keypoint detections captured by a single vehicle is desired, the keypoint detections will usually overlap. Accordingly, connecting the keypoint detections in chronological order may result in a lane line that that exhibits erratic characteristics (e.g., moves back and forth), which is undesirable.

### SUMMARY

In one embodiment, example systems and methods relate to a manner of improving data about a roadway used in downstream processes, such as in maps, by applying a heuristic-based approach to estimate lane lines from key point detections. As previously noted, accurately portraying lane lines from machine-based observations can be a complex task that encounters many different difficulties. That is, detections of lane lines may vary such that one detection to the next are not centered on the lane line itself but may be on an edge, directly adjacent, etc. Moreover, spurious aberrations in sensor operation or environmental conditions may further vary the locations of the detections relative to the actual lane line. As such, generating a lane line directly from the raw sensor data may result in significant deviations from a real lane line, and downstream tasks may, therefore, suffer from degraded accuracy.

Therefore, in at least one approach, an inventive system is disclosed that generates improved lane lines for subsequent use. In one aspect, the inventive system employs a heuristic to estimate the lane lines by initially acquiring the sensor data that includes observations of a roadway and transferring headings from each frame to the key point detections of the lane lines. That is, for example, the sensor data is embodied as frames, which may be formed into a frame graph, with the separate frames associated with key point detections in the surrounding environment. In general, the key point detections may include detections of lane lines and other features, such as road edges, poles, etc. The frames themselves are locations of probe vehicles at points where the probe vehicles acquire the key point detections and log a current location and heading of the probe vehicle. Thus, the frames may be formed into a frame graph that associates separate ego traces (i.e., traces from the same vehicle).

The inventive system uses the heading information from the frames and assigns the headings to the key point detections of a lane line that is being estimated as an initial data preparation process of the heuristic. The system then selects a point to begin estimating the lane line and identifies nearby points within a defined radius of the selected point. Using these points, the system extends an orthogonal line from the selected point in a direction that is perpendicular to a heading associated with the selected point. Using the orthogonal line, the system projects lines from the nearby points to the orthogonal line such that the projected lines are perpendicular to the orthogonal line itself. Intersections of the projected lines with the orthogonal line define projection points.

In at least one arrangement, the system then averages the locations of the projection points along the orthogonal line to define an estimated line point that is the estimation of the lane line. The system then iterates this process by identifying a new selected point, a defined distance from the initial selected point in a direction of the heading of the initial selected point. Thereafter, the system connects the line points to define the lane line. The estimated lane line can then be provided to a mapping pipeline to facilitate creating lane maps within the broader mapping of the roadway, which may be used by autonomous vehicles for autonomous navigation and/or other systems for relevant tasks. In this way, the system is able to improve the quality of the lane line, thereby improving the accuracy of the downstream tasks.

In one embodiment, a mapping system for improving the estimation of lane lines along a roadway is disclosed. The mapping system includes one or more processors and a memory communicably coupled to the one or more processors. The memory stores instructions that, when executed by the one or more processors, cause the one or more processors to acquire sensor data about the roadway. The sensor data includes at least frames and associated point detections about a lane line associated with the roadway. The instructions include instructions to identify a selected point and nearby points of the point detections. The instructions include instructions to project lines from the nearby points to an orthogonal line extending from the selected point to define projection points. The instructions include instructions to estimate a line point of the lane line according to the projection points. The instructions include instructions to generate an estimated line for the lane line using the line point and other line points.

In one embodiment, a non-transitory computer-readable medium including instructions that, when executed by one or more processors, cause the one or more processors to perform one or more functions is disclosed. The instructions include instructions to acquire sensor data about the roadway. The sensor data includes at least frames and associated point detections about a lane line associated with the roadway. The instructions include instructions to identify a selected point and nearby points of the point detections. The instructions include instructions to project lines from the nearby points to an orthogonal line extending from the selected point to define projection points. The instructions include instructions to estimate a line point of the lane line according to the projection points. The instructions include instructions to generate an estimated line for the lane line using the line point and other line points.

In one embodiment, a method is disclosed. In one embodiment, the method includes acquiring sensor data about a roadway. The sensor data includes at least frames and associated point detections about a lane line associated with the roadway. The method includes identifying a selected point and nearby points of the point detections. The method includes projecting lines from the nearby points to an orthogonal line extending from the selected point to define projection points. The method includes estimating a line point of the lane line according to the projection points. The method includes generating an estimated line for the lane line using the line point and other line points.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a mapping system that is associated with estimating lane lines.

FIG. 2 illustrates one embodiment of the mapping system of FIG. 2 in a cloud-computing environment.

FIG. 3 illustrates a flowchart for one embodiment of a method that is associated with estimating lane lines.

FIGS. 4A-D illustrate examples of a heuristic implemented by the mapping system at processing sensor data into lane lines.

FIG. 5 illustrates one embodiment of a vehicle within which systems and methods disclosed herein may be implemented.

### DETAILED DESCRIPTION

Systems, methods, and other embodiments associated with improving the identification of lanes using a heuristic-based approach are disclosed. As previously noted, accurately portraying lane lines from machine-based observations can be complex. Detections of lane lines relative to the actual lane line may exhibit significant variance. As such, generating a lane line directly from the raw sensor data may result in lines that are not straight, which may degrade the accuracy of tasks that rely on precise determinations of lane lines.

An inventive system is disclosed that resolves the noted difficulties by considering positions of multiple separate detections when resolving each subsequent line point of a lane line. In one aspect, the inventive system employs a heuristic to estimate the lane lines by initially acquiring the sensor data that includes observations of a roadway and transferring headings from each frame to the key point detections of the lane lines. That is, for example, the sensor data is embodied as frames, which may be formed into a frame graph, with the separate frames associated with key point detections in the surrounding environment. In general, the key point detections may include detections of lane lines and other features, such as road edges, poles, etc. The frames themselves are locations of probe vehicles at points where the probe vehicles acquire the key point detections and log a current location and heading of the probe vehicle. Thus, the frames may be formed into a frame graph that associates separate ego traces (i.e., traces from the same vehicle).

The inventive system uses the heading information from the frames and assigns the headings to the key point detections of a lane line that is being estimated, as an initial data preparation process of the heuristic. The system then selects a point to begin estimating the lane line and identifies nearby points within a defined radius of the selected point. Using these points, the system extends an orthogonal line from the selected point in a direction that is perpendicular to a heading associated with the selected point. Using the orthogonal line, the system projects lines from the nearby points to the orthogonal line such that the projected lines are perpendicular to the orthogonal line itself. Intersections of the projected lines with the orthogonal line define projection points.

In at least one arrangement, the system then averages the locations of the projection points along the orthogonal line to define an estimated line point that is the estimation of the lane line. The system then iterates this process by identifying a new selected point, a defined distance from the initial selected point in a direction of the heading of the the prior selected point. Thereafter, the system connects the line points to define the lane line. The estimated lane line can then be provided to a mapping pipeline to facilitate creating lane maps within the broader mapping of the roadway, which may be used by autonomous vehicles for autonomous navigation and/or other systems for relevant tasks. In this way, the system is able to improve the quality of the lane line, thereby improving the accuracy of the downstream tasks.

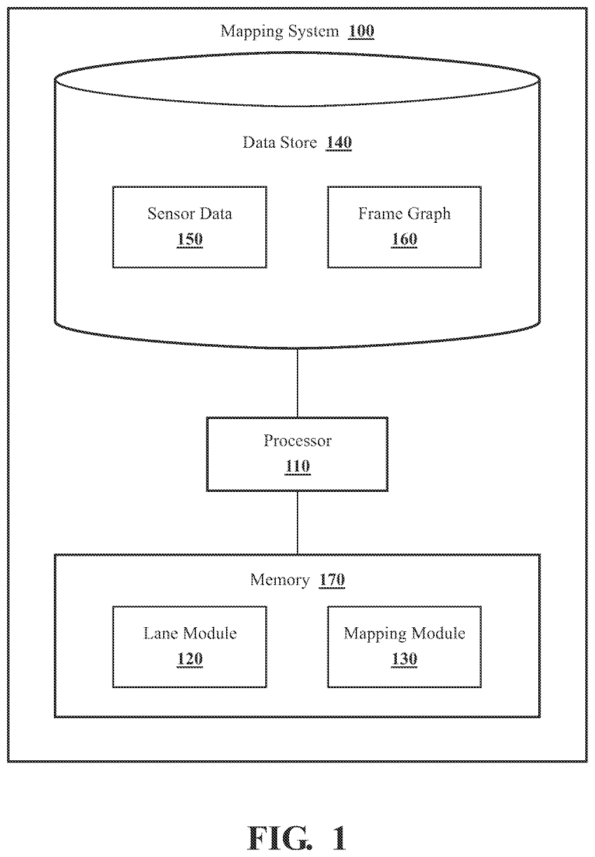

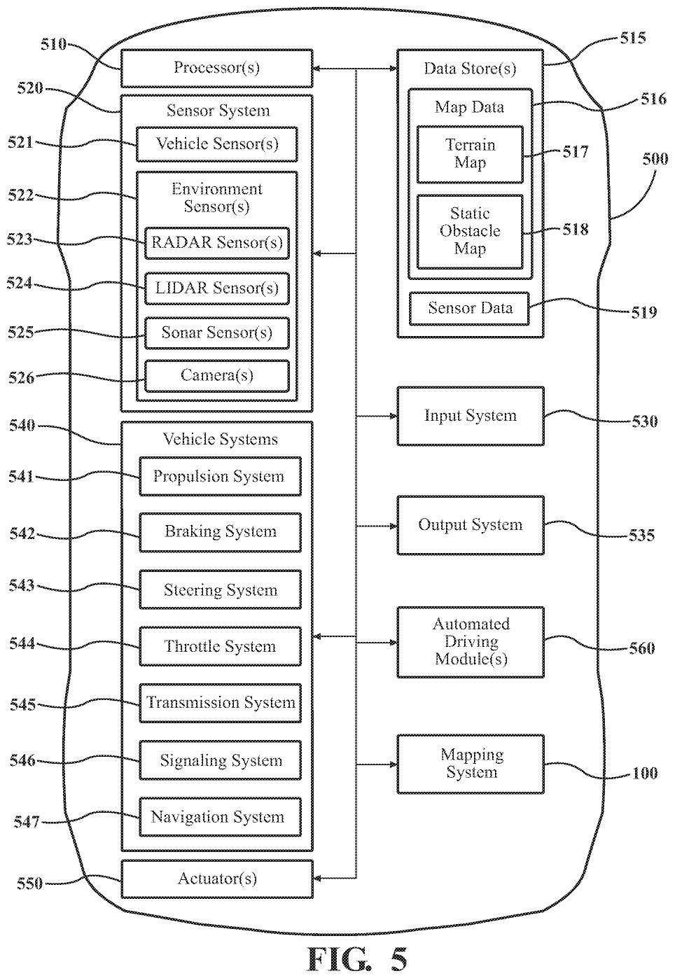

With reference to FIG. 1, one embodiment of a mapping system 100 is further illustrated. The mapping system 100 is shown as including a processor 110, which may be from a vehicle 500 of FIG. 5 or may be associated with a separate computing device, such as a server, cloud-computing system, and so on. Accordingly, the processor 110 may be a part of the mapping system 100, the mapping system 100 may include a separate processor from the processor 510 of the vehicle 500, or the mapping system 100 may access the processor 110 through a data bus or another communication path. In one embodiment, the mapping system 100 includes a memory 170 that stores a lane module 120 and a mapping module 130. The memory 170 is a random-access memory (RAM), read-only memory (ROM), a hard-disk drive, a flash memory, or another suitable memory for storing the modules 120 and 130. The modules 120 and 130 are, for example, computer-readable instructions that, when executed by the processor 110, cause the processor 110 to perform the various functions disclosed herein. In alternative arrangements, the modules 120 and 130 are independent elements from the memory 170 that are, for example, comprised of hardware elements (e.g., arrangements of logic gates). Thus, the modules 120 and 130 are alternatively ASICs, hardware-based controllers, a composition of logic gates, or another hardware-based solution.

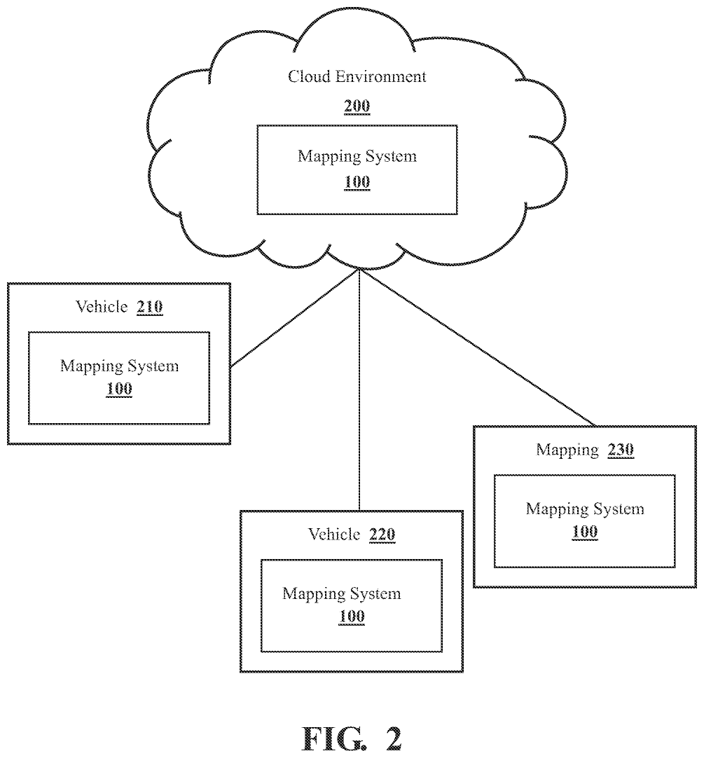

The mapping system 100, as illustrated in FIG. 1, is generally an abstracted form of the mapping system 100 as may be implemented between the vehicle 500 and a cloud-computing environment 200 or independently within the cloud-computing environment 200. FIG. 2 illustrates one example of a cloud-computing environment 200 that may be implemented along with the mapping system 100. As illustrated in FIG. 2, the mapping system 100 is embodied, at least in part, within the cloud-computing environment 200.

In one or more approaches, the cloud environment 200 may facilitate communications between multiple different vehicles to at least acquire information from the vehicles 210, 220, and 230. Accordingly, as shown, the mapping system 100 may include separate instances within one or more entities of the cloud-based environment 200, such as servers, and also instances within vehicles that function cooperatively to acquire, analyze, and distribute the noted information. In a further aspect, the entities that implement the mapping system 100 within the cloud-based environment 200 may vary beyond transportation-related devices and encompass mobile devices (e.g., smartphones), and other devices that may benefit from the functionality and/or generated maps discussed herein. Thus, the set of entities that function in coordination with the cloud environment 200 may be varied.

In one approach, functionality associated with at least one module of the mapping system 100 is implemented within the vehicle 500, while further functionality is implemented within a cloud-based computing system. Thus, the mapping system 100 may include a local instance at the vehicle 500 that, for example, functions to collect sensor data and a remote instance that functions within the cloud-based environment to process the sensor data.

Moreover, the mapping system 100, as provided for herein, may function in cooperation with a communication system. In one embodiment, the communication system communicates according to one or more communication standards. For example, the communication system can include multiple different antennas/transceivers and/or other hardware elements for communicating at different frequencies and according to respective protocols. The communication system, in one arrangement, communicates via a communication protocol, such as a WiFi, DSRC, V2I, V2V, or another suitable protocol for communicating between the vehicle and other entities in the cloud environment. Moreover, the communication system, in one arrangement, further communicates according to a protocol, such as global system for mobile communication (GSM), Enhanced Data Rates for GSM Evolution (EDGE), Long-Term Evolution (LTE), 5G, or another communication technology that provides for the vehicle communicating with various remote devices (e.g., a cloud-based server). In any case, the mapping system 100 can leverage various wireless communication technologies to provide communications to other entities, such as members of the cloud-computing environment.

With continued reference to FIG. 1, in one embodiment, the mapping system 100 includes the data store 140. The data store 140 is, in one embodiment, an electronic data structure stored in the memory 170 or another data storage device that is configured with routines that can be executed by the processor 110 for analyzing stored data, providing stored data, organizing stored data, and so on. Thus, in one embodiment, the data store 140 stores data used by the modules 120 and 130 in executing various functions. In one embodiment, the data store 140 stores the sensor data 150, and the frame graph 160.

The lane module 120 generally includes instructions that function to control the processor 110 to acquire data inputs that form the sensor data. In various arrangements, the sensor data 150 may be acquired from separate remote devices, such as probe vehicles, satellites, aerial imaging platforms (e.g., drones, planes, etc.), and so on. For example, the lane module 120 may communicate directly with the collection mechanisms or through a service that acquires the sensor data 150 and then routes the sensor data 150 to the lane module 120. In further aspects, the lane module 120 may acquire additional data as part of the sensor data 150 and thus may communicate with multiple different sources.

For example, the sensor data 150 can include, in one embodiment, trace data that is comprised of frames and observations of attributes of the roadway and other aspects of the surrounding environment. The frames are locations of probe vehicles as the probe vehicles travel along a roadway. The frames can include further information beyond a simple location, such as characteristics of the trajectory (e.g., directional heading), key point detections, and so on. The frames may be further formed into the frame graph 160, which frames associated with the same traversal of the roadway by a vehicle. Thus, the frame graph 160 can show which frames are associated and, thus, which key point detections are associated with the same lane line. The key point detections, as briefly described above, are pointed-based detections of features in the surrounding environment that may include features of the roadway (e.g., lane lines, road markings, etc.) and objects proximate to and on the roadway (e.g., poles, signs, etc.). In further approaches, the sensor data 150 may further include orthographic images of the roadway, which may be subsequently translated into key point detections associated with features of the roadway.

As provided for herein, the lane module 120, in one embodiment, acquires the sensor data 150 from various sensors of probe vehicles and/or other observation platforms, including cameras, GPS, etc. In further arrangements, the lane module 120 acquires the sensor data 150 from further sensors such as a radar 523, a LiDAR 524, and other sensors as may be suitable for identifying aspects of the roadway and surrounding environment. Moreover, while raw sensor information is described, the lane module 120 may further acquire processed data that forms derived observations of the surrounding environment, such as the key point detections of lane markers, road boundaries, signs, traffic signals, and so on.

Accordingly, the lane module 120, in one embodiment, controls the respective sensors to provide the data inputs in the form of the sensor data 150 or at least receives the sensor data via one or more intermediaries therefrom. Moreover, the lane module 120 can undertake various approaches to fuse data from multiple sensors when providing the sensor data 150 and/or from sensor data acquired over a wireless communication link (e.g., v2v) from one or more of the surrounding vehicles. Thus, the sensor data 150, in one embodiment, represents a combination of perceptions acquired from multiple sensors and multiple separate vehicles. In general, the sensor data 150 includes at least the frames and key point detections (also referred to as point detections herein). In further aspects, the sensor data 150 includes, additionally or alternatively, radar imaging, LiDAR imaging, or another source of data that provides information about the roadway.

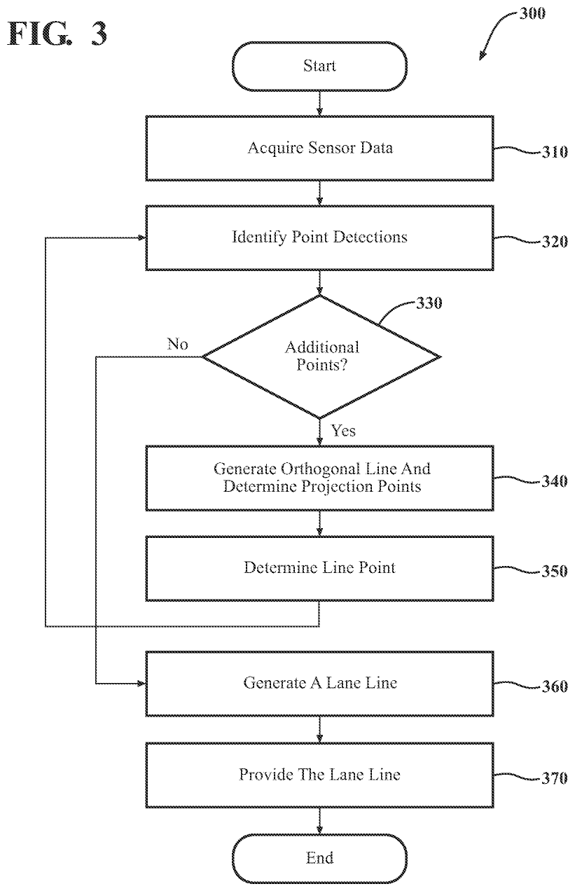

The lane module 120, in one embodiment, includes instructions that cause the processor 110 to initially acquire the sensor data 150 and then, in at least one approach, process the sensor data 150 according to the heuristic in order to derive estimated points on the lane line. The lane module 120 implements the heuristic to iteratively assess groups of detection points from the sensor data 150. Thus, the lane module 120 may begin the estimation process by randomly selecting a detection point for an area that is to be mapped, selecting a detection at the beginning of a roadway (e.g., from a specific intersection), or according to another routine. According to the various implementations for determining an initial point, the lane module 120 may undertake variations in the overall process, such as progressing in both directions and merging the estimated lane lines when beginning by selecting a random point. However, the overall process as outlined herein remains consistent for these variations. In any case, the lane module 120 initiates the heuristic and iteratively processes detection points along a roadway to derive the lane line. Further aspects of the heuristic will be described subsequently, along with method 300 of FIG. 3.

The mapping module 130, in one embodiment, includes instructions that cause the processor 110 to use the estimated lane line derived by the lane module 120 for various downstream tasks. For example, in one approach, the mapping module 130 uses the estimated lane line to construct a map, such as a lane map, a high-definition map, or another map that may be used by other entities for control/navigation along a roadway. In one configuration, the mapping module 130 generates the lane map from the estimated lane line and other estimated lane lines and then provides the lane map as an input into a planning and control subsystem of an autonomous or semi-autonomous vehicle, such as the vehicle 500. That is, by employing the improved accuracy of the lane map with the estimated lane line, the vehicle 500 is able to better navigate the roadway and plan subsequent actions along the roadway.

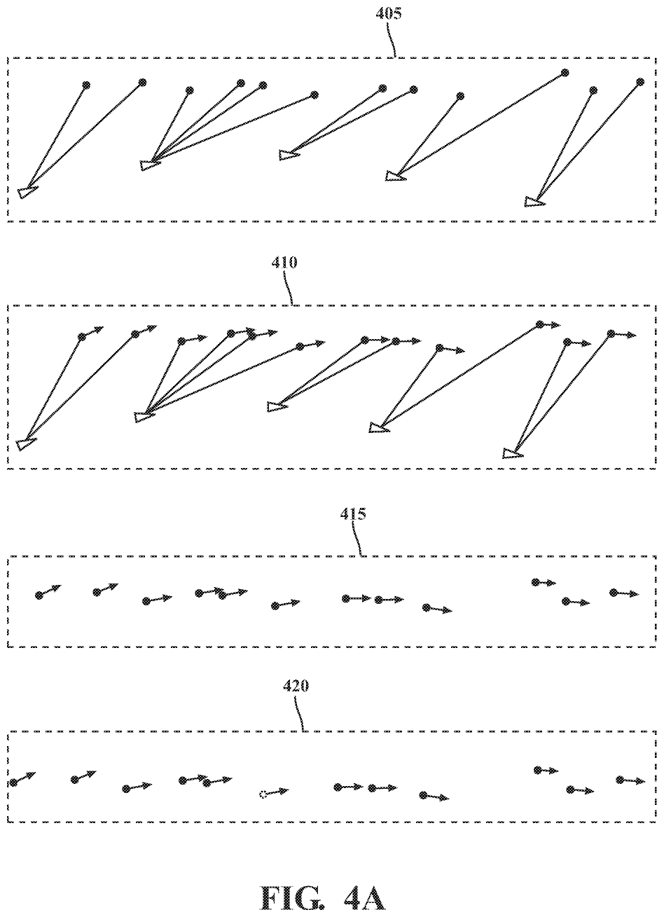

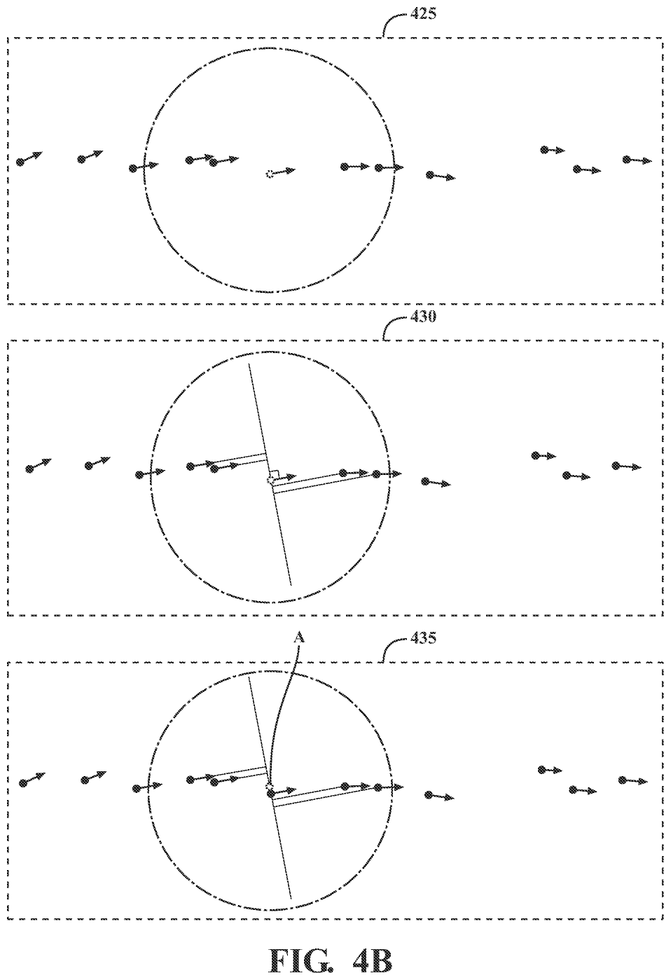

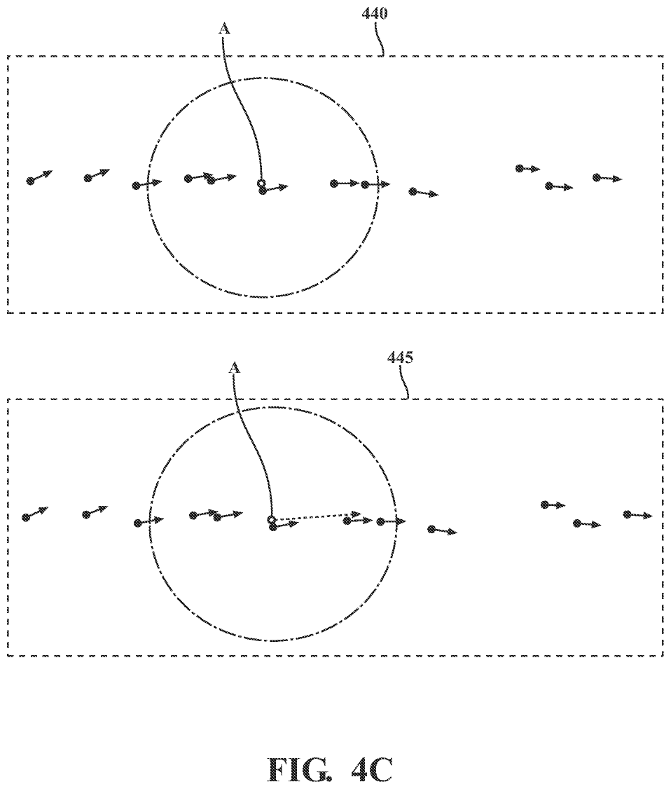

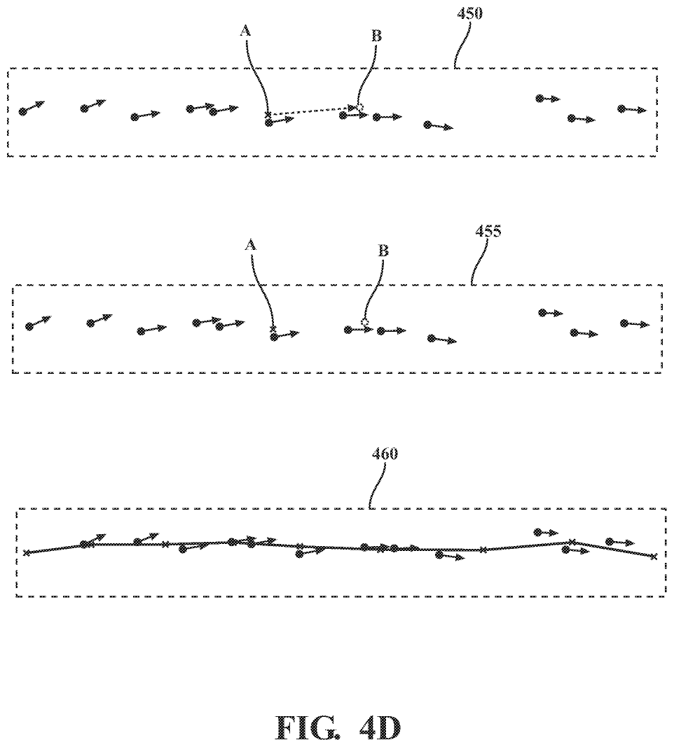

Additional aspects of estimating lane lines using a heuristic will be discussed in relation to FIG. 3. FIG. 3 illustrates a flowchart of a method 300 that is associated with estimating lane lines from key point detections. Method 300 will be discussed from the perspective of the mapping system 100 of FIGS. 1, and 2. While method 300 is discussed in combination with the mapping system 100, it should be appreciated that the method 300 is not limited to being implemented within the mapping system 100 but is instead one example of a system that may implement the method 300. Moreover, the method 300 will be describe along with FIGS. 4A-D.

At 310, the lane module 120 acquires the sensor data 150 about a roadway. In one example, the sensor data 150 is embodied as frames and associated point detections about a lane line associated with the roadway. As previously described, the frames are discretized locations of a vehicle along the roadway. Thus, a series of frames from the same vehicle define a trace or path of that vehicle as the vehicle traverse the roadway. Moreover, at each separate frame, an associated vehicle acquires the point detections. In general, the point detections (also referred to as key point detections herein) are machine-identified points of the lane line from the vehicle using sensors to sense and process associated data into the perceptions at the separate frames. Thus, each separate frame may be associated with multiple different point detections. One example of the sensor data 150 is shown in FIG. 4A within block 405. As illustrated, the five separate frames, represented via triangles, are each associated with multiple separate point detections of a lane line, which are shown as points linked to each of the frames. It should be appreciated that the separate frames may be linked within the frame graph 160 to show correspondence with a single vehicle. Thus, in practice, the point detections may be more numerous than illustrated and may include detections from multiple separate vehicles with separate associated traces of frames along the roadway. As another note, the illustration of FIG. 4A represents the analysis of a single lane line. However, the separate frames generally include detections of left and right lanes and may further extend to lane lines of other lanes. Thus, the example of FIGS. 4A-D is provided for illustrative purposes and does not fully represent the data that may be included with a frame, nor the whole process undertaken by the mapping system 100.

As a further aspect of acquiring the sensor data 150, the lane module 120, as shown at 410 of FIG. 4A, assigns headings from frames to respective ones of the detection points. This additional pre-processing of the sensor data 150 provides for consolidating useful information about the lane into a single data object that is the detection point for subsequent use within the heuristic. In further aspects, the lane module 120 may perform further processing, such as removal of spurious aberrations within the sensor data 150 (i.e., points that deviate from a mean by some threshold). As shown in block 415 of FIG. 4A, the lane module 120 may further remove extra data once the headings have been assigned, which may include removing the frames themselves to leave data explicitly associated with the lane line. In any case, the lane module 120 initially acquires and prepares the information for processing by the heuristic.

At 320, the lane module 120 identifies point detections. In particular, the lane module 120 identifies a selected point and nearby points of the point detections. Depending on a current stage of the heuristic, the process of identifying the selected point may differ. For example, to initiate the heuristic overall, the lane module 120 may randomly select a point detection to initiate processing, may select a point detection of a lane line at an intersection, or according to another particular point that logically delineates unmapped from mapped areas. For subsequent iterations of the heuristic, the lane module 120 projects a cursor line from a prior estimated line point a defined distance to define a subsequent selected point for performing a next iteration. Thus, depending on whether the lane module 120 is initiating the heuristic overall or is executing a subsequent iteration, the identification of the selected point may differ. As shown in FIG. 4A, the lane module 120 has randomly selected one of the detection points as the selected point.

In addition to identifying the selected point for performing the heuristic, the lane module also identifies nearby points of the selected point at 320. As shown in block 425 of FIG. 4B, the lane module 120 defines a search radius around the selected point for locating the point detections within the search radius as the nearby points. That is, the lane module 120 uses the selected point as a center point of a circle with the search radius as the radius of the circle. The point detections that are within the circle are then identified as the nearby points with which the lane module 120 performs the heuristic. The nearby points function as a reference for the lane module 120 about a probable form of the lane line as the lane line moves near the selected point.

At 330, the lane module 120 determines whether the search within the circle returned any nearby points or not. That is, if the search returns new nearby points that have not been previously identified, then the lane module 120 has not reached an end position of the lane line, and the lane module 120 proceeds with the processing, as described at block 340. However, if the lane module 120 determines that no new nearby points are present, then the lane module 120 determines that the lane line has ended or there is not adequate information to continue. In this case, the lane module 120 proceeds to defining the estimated lane line, at block 360, which will be discussed further subsequently.

At 340, the lane module 120 generates an orthogonal line and also determines projection points. In one arrangement, the lane module generates the orthogonal line by extending the orthogonal line from the selected point along an axis that is perpendicular to a heading associated with the selected point. As shown in block 430 of FIG. 4B, the orthogonal line is extended in both directions away from the selected point, generally within an extent of the circle that the lane module 120 generated at 320. The lane module 120 then uses this orthogonal line to define projection points associated with the nearby points. That is, the lane module 120 projects lines from the nearby points to the orthogonal. The projected lines are projected to be perpendicular to the orthogonal line. The points of intersection of the projected lines with the orthogonal line defines the projected points, which the lane module 120 uses to derive the estimate line point.

At 350, the lane module 120 determines the line point for the present iteration and/or a vertex pose. In one configuration, the lane module 120 uses a simple average of the locations of the projected points and the selected point along the line to determine a position of the line point. In further examples, the lane module 120 may use another approach, such as a weighted average, a median value, a root mean square, etc. Moreover, determining the vertex pose may involve determining the line point/vertex in addition to a heading direction associated with the vertex, as described subsequently. In any case, the lane module 120 determines the location of the line point along the axis of the orthogonal line. As shown in FIG. 4B at block 435, the line point is denoted as point A and represents an average of the locations along the orthogonal line. After determining the line point, at 350, the lane module 120 proceeds to a subsequent iteration.

Thus, as shown in FIG. 4C, block 440 illustrates a starting point for determining a next selected point from line point A. That is, at 320, the lane module 120 projects a cursor line, as shown in block 445 of FIG. 4C in a direction of a heading associated with the selected point. The lane module 120 extends the line point by a defined distance that may be based on a granularity of the available data and/or a desired resolution of the lane line. Moreover, in a further aspect, the lane module 120 may define the direction for extending the cursor line according to a median or average of headings for the nearby points. In any case, the lane module 120 defines a subsequent selected point B as the end point of the projected cursor line, as shown at 450 and 455 of FIG. 4D. The lane module 120 then repeats the functions described at 320-350 until an end condition is satisfied. The end condition may vary depending on a particular implementation. For example, the end condition generally defines a threshold number of new points returned from the search at 320 such that when no further new detection points are identified, then the process of determining line points exits. Alternatively, the end condition may be a predefined distance of a segment that is being mapped. In any case, once the lane module 120 determines that the end condition is satisfied (e.g., met or exceeded), then the lane module 120 proceeds to connect the line points, as described at block 360.

At 360, the lane module 120 generating an estimated line for the lane line using the estimated line points. In general, the lane module 120 simply connects the separate line points with line segments in order to define the lane line. Of course, in further approaches, the lane module 120 may implement a more complex approach, such as the use of line fitting techniques, or other fitting (e.g., spline fitting, etc.). Moreover, while generating the estimated line is described as a discrete step where all points are connected at once, in various approaches, the lane module 120 may instead connect the line points as they are created. Whichever approach is undertaken, the mapping system 100 functions to generate lane lines for use in a mapping pipeline or other downstream processes.

At 370, the mapping module 130 provides the lane line. In one approach, the mapping module 130 generates a map of a roadway and subsequently controls a vehicle using the map according to one or more automated functions (e.g., autonomous control, ADAS, etc.). Broadly, the mapping module 130 uses the lane line and similarly generated lane lines to define lanes along a roadway as an independent lane map or as lanes depicted within a broader map of the roadway and surroundings. Information conveyed by an accurate accounting of the lanes via the lane lines provides for defining traversable areas and also conveys information about how to navigate a particular section of roadway with respect to turns, and so on. Thus, the mapping module 130 generates the map with this information and provides the information to planning and control systems of vehicles so that the vehicles can effectively navigate the roadways. Because the lane lines generated by the mapping system 100 using the noted heuristic are of an improved quality, the vehicle is able to more precisely plan for various features within the roadway and ultimately control the vehicle in an improved manner. In this way, the mapping system 100 improves the mapping process and downstream functions of vehicles and other entities that rely on the maps.

Referring to FIG. 5, an example of a vehicle 500 is illustrated. As used herein, a “vehicle” is any form of transport that may be motorized or otherwise powered. In one or more implementations, the vehicle 500 is an automobile. While arrangements will be described herein with respect to automobiles, it will be understood that embodiments are not limited to automobiles. In some implementations, the vehicle 500 may be a robotic device or a form of transport that, for example, includes sensors to perceive aspects of the surrounding environment, and thus benefits from the functionality discussed herein.

The vehicle 500 also includes various elements. It will be understood that in various embodiments, it may not be necessary for the vehicle 500 to have all of the elements shown in FIG. 5. The vehicle 500 can have different combinations of the various elements shown in FIG. 5. Further, the vehicle 500 can have additional elements to those shown in FIG. 5. In some arrangements, the vehicle 500 may be implemented without one or more of the elements shown in FIG. 5. While the various elements are shown as being located within the vehicle 500 in FIG. 5, it will be understood that one or more of these elements can be located external to the vehicle 500. Further, the elements shown may be physically separated by large distances. For example, as discussed, one or more components of the disclosed system can be implemented within a vehicle while further components of the system are implemented within a cloud-computing environment or other system that is remote from the vehicle 500.

It will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In any case, the vehicle 500 includes a mapping system 100 that is implemented to perform methods and other functions as disclosed herein relating to improving mapping through synthesizing probe data.

FIG. 5 will now be discussed in full detail as an example environment within which the system and methods disclosed herein may operate. In some instances, the vehicle 500 is configured to switch selectively between an autonomous mode, one or more semi-autonomous modes, and/or a manual mode. “Manual mode” means that all of or a majority of the control and/or maneuvering of the vehicle is performed according to inputs received via manual human-machine interfaces (HMIs) (e.g., steering wheel, accelerator pedal, brake pedal, etc.) of the vehicle 500 as manipulated by a user (e.g., human driver). In one or more arrangements, the vehicle 500 can be a manually-controlled vehicle that is configured to operate in only the manual mode.

In one or more arrangements, the vehicle 500 implements some level of automation in order to operate autonomously or semi-autonomously. As used herein, automated control of the vehicle 500 is defined along a spectrum according to the SAE J3016 standard. The SAE J3016 standard defines six levels of automation from level zero to five. In general, as described herein, semi-autonomous mode refers to levels zero to two, while autonomous mode refers to levels three to five. Thus, the autonomous mode generally involves control and/or maneuvering of the vehicle 500 along a travel route via a computing system to control the vehicle 500 with minimal or no input from a human driver. By contrast, the semi-autonomous mode, which may also be referred to as advanced driving assistance system (ADAS), provides a portion of the control and/or maneuvering of the vehicle via a computing system along a travel route with a vehicle operator (i.e., driver) providing at least a portion of the control and/or maneuvering of the vehicle 500.

With continued reference to the various components illustrated in FIG. 5, the vehicle 500 includes one or more processors 510. In one or more arrangements, the processor(s) 510 can be a primary/centralized processor of the vehicle 500 or may be representative of many distributed processing units. For instance, the processor(s) 510 can be an electronic control unit (ECU). Alternatively, or additionally, the processors include a central processing unit (CPU), a graphics processing unit (GPU), an ASIC, an microcontroller, a system on a chip (SoC), and/or other electronic processing units that support operation of the vehicle 500.

The vehicle 500 can include one or more data stores 515 for storing one or more types of data. The data store 515 can be comprised of volatile and/or non-volatile memory. Examples of memory that may form the data store 515 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, solid-state drivers (SSDs), and/or other non-transitory electronic storage medium. In one configuration, the data store 515 is a component of the processor(s) 510. In general, the data store 515 is operatively connected to the processor(s) 510 for use thereby. The term “operatively connected,” as used throughout this description, can include direct or indirect connections, including connections without direct physical contact.

In one or more arrangements, the one or more data stores 515 include various data elements to support functions of the vehicle 500, such as semi-autonomous and/or autonomous functions. Thus, the data store 515 may store map data 516 and/or sensor data 519. The map data 516 includes, in at least one approach, maps of one or more geographic areas. In some instances, the map data 516 can include information about roads (e.g., lane and/or road maps), traffic control devices, road markings, structures, features, and/or landmarks in the one or more geographic areas. The map data 516 may be characterized, in at least one approach, as a high-definition (HD) map that provides information for autonomous and/or semi-autonomous functions.

In one or more arrangements, the map data 516 can include one or more terrain maps 517. The terrain map(s) 517 can include information about the ground, terrain, roads, surfaces, and/or other features of one or more geographic areas. The terrain map(s) 517 can include elevation data in the one or more geographic areas. In one or more arrangements, the map data 516 includes one or more static obstacle maps 518. The static obstacle map(s) 518 can include information about one or more static obstacles located within one or more geographic areas. A “static obstacle” is a physical object whose position and general attributes do not substantially change over a period of time. Examples of static obstacles include trees, buildings, curbs, fences, and so on.

The sensor data 519 is data provided from one or more sensors of the sensor system 520. Thus, the sensor data 519 may include observations of a surrounding environment of the vehicle 500 and/or information about the vehicle 500 itself. In some instances, one or more data stores 515 located onboard the vehicle 500 store at least a portion of the map data 516 and/or the sensor data 519. Alternatively, or in addition, at least a portion of the map data 516 and/or the sensor data 519 can be located in one or more data stores 515 that are located remotely from the vehicle 500.

As noted above, the vehicle 500 can include the sensor system 520. The sensor system 520 can include one or more sensors. As described herein, “sensor” means an electronic and/or mechanical device that generates an output (e.g., an electric signal) responsive to a physical phenomenon, such as electromagnetic radiation (EMR), sound, etc. The sensor system 520 and/or the one or more sensors can be operatively connected to the processor(s) 510, the data store(s) 515, and/or another element of the vehicle 500.

Various examples of different types of sensors will be described herein. However, it will be understood that the embodiments are not limited to the particular sensors described. In various configurations, the sensor system 520 includes one or more vehicle sensors 521 and/or one or more environment sensors. The vehicle sensor(s) 521 function to sense information about the vehicle 500 itself. In one or more arrangements, the vehicle sensor(s) 521 include one or more accelerometers, one or more gyroscopes, an inertial measurement unit (IMU), a dead-reckoning system, a global navigation satellite system (GNSS), a global positioning system (GPS), and/or other sensors for monitoring aspects about the vehicle 500.

As noted, the sensor system 520 can include one or more environment sensors 522 that sense a surrounding environment (e.g., external) of the vehicle 500 and/or, in at least one arrangement, an environment of a passenger cabin of the vehicle 500. For example, the one or more environment sensors 522 sense objects the surrounding environment of the vehicle 500. Such obstacles may be stationary objects and/or dynamic objects. Various examples of sensors of the sensor system 520 will be described herein. The example sensors may be part of the one or more environment sensors 522 and/or the one or more vehicle sensors 521. However, it will be understood that the embodiments are not limited to the particular sensors described. As an example, in one or more arrangements, the sensor system 520 includes one or more radar sensors 523, one or more LIDAR sensors 524, one or more sonar sensors 525 (e.g., ultrasonic sensors), and/or one or more cameras 526 (e.g., monocular, stereoscopic, RGB, infrared, etc.).

Continuing with the discussion of elements from FIG. 5, the vehicle 500 can include an input system 530. The input system 530 generally encompasses one or more devices that enable the acquisition of information by a machine from an outside source, such as an operator. The input system 530 can receive an input from a vehicle passenger (e.g., a driver/operator and/or a passenger). Additionally, in at least one configuration, the vehicle 500 includes an output system 535. The output system 535 includes, for example, one or more devices that enable information/data to be provided to external targets (e.g., a person, a vehicle passenger, another vehicle, another electronic device, etc.).

Furthermore, the vehicle 500 includes, in various arrangements, one or more vehicle systems 540. Various examples of the one or more vehicle systems 540 are shown in FIG. 5. However, the vehicle 500 can include a different arrangement of vehicle systems. It should be appreciated that although particular vehicle systems are separately defined, each or any of the systems or portions thereof may be otherwise combined or segregated via hardware and/or software within the vehicle 500. As illustrated, the vehicle 500 includes a propulsion system 541, a braking system 542, a steering system 543, a throttle system 544, a transmission system 545, a signaling system 546, and a navigation system 547.

The navigation system 547 can include one or more devices, applications, and/or combinations thereof to determine the geographic location of the vehicle 500 and/or to determine a travel route for the vehicle 500. The navigation system 547 can include one or more mapping applications to determine a travel route for the vehicle 500 according to, for example, the map data 516. The navigation system 547 may include or at least provide connection to a global positioning system, a local positioning system or a geolocation system.

In one or more configurations, the vehicle systems 540 function cooperatively with other components of the vehicle 500. For example, the processor(s) 510, the mapping system 100, and/or automated driving module(s) 560 can be operatively connected to communicate with the various vehicle systems 540 and/or individual components thereof. For example, the processor(s) 510 and/or the automated driving module(s) 560 can be in communication to send and/or receive information from the various vehicle systems 540 to control the navigation and/or maneuvering of the vehicle 500. The processor(s) 510, the mapping system 100, and/or the automated driving module(s) 560 may control some or all of these vehicle systems 540.

For example, when operating in the autonomous mode, the processor(s) 510, the mapping system 100, and/or the automated driving module(s) 560 control the heading and speed of the vehicle 500. The processor(s) 510, the mapping system 100, and/or the automated driving module(s) 560 cause the vehicle 500 to accelerate (e.g., by increasing the supply of energy/fuel provided to a motor), decelerate (e.g., by applying brakes), and/or change direction (e.g., by steering the front two wheels). As used herein, “cause” or “causing” means to make, force, compel, direct, command, instruct, and/or enable an event or action to occur either in a direct or indirect manner.

As shown, the vehicle 500 includes one or more actuators 550 in at least one configuration. The actuators 550 are, for example, elements operable to move and/or control a mechanism, such as one or more of the vehicle systems 540 or components thereof responsive to electronic signals or other inputs from the processor(s) 510 and/or the automated driving module(s) 560. The one or more actuators 550 may include motors, pneumatic actuators, hydraulic pistons, relays, solenoids, piezoelectric actuators, and/or another form of actuator that generates the desired control.

As described previously, the vehicle 500 can include one or more modules, at least some of which are described herein. In at least one arrangement, the modules are implemented as non-transitory computer-readable instructions that, when executed by the processor 510, implement one or more of the various functions described herein. In various arrangements, one or more of the modules are a component of the processor(s) 510, or one or more of the modules are executed on and/or distributed among other processing systems to which the processor(s) 510 is operatively connected. Alternatively, or in addition, the one or more modules are implemented, at least partially, within hardware. For example, the one or more modules may be comprised of a combination of logic gates (e.g., metal-oxide-semiconductor field-effect transistors (MOSFETs)) arranged to achieve the described functions, an application-specific integrated circuit (ASIC), programmable logic array (PLA), field-programmable gate array (FPGA), and/or another electronic hardware-based implementation to implement the described functions. Further, in one or more arrangements, one or more of the modules can be distributed among a plurality of the modules described herein. In one or more arrangements, two or more of the modules described herein can be combined into a single module.

Furthermore, the vehicle 500 may include one or more automated driving modules 560. The automated driving module(s) 560, in at least one approach, receive data from the sensor system 520 and/or other systems associated with the vehicle 500. In one or more arrangements, the automated driving module(s) 560 use such data to perceive a surrounding environment of the vehicle. The automated driving module(s) 560 determine a position of the vehicle 500 in the surrounding environment and map aspects of the surrounding environment. For example, the automated driving module(s) 560 determines the location of obstacles or other environmental features including traffic signs, trees, shrubs, neighboring vehicles, pedestrians, etc.

The automated driving module(s) 560 either independently or in combination with the mapping system 100 can be configured to determine travel path(s), current autonomous driving maneuvers for the vehicle 500, future autonomous driving maneuvers and/or modifications to current autonomous driving maneuvers based on data acquired by the sensor system 520 and/or another source. In general, the automated driving module(s) 560 functions to, for example, implement different levels of automation, including advanced driving assistance (ADAS) functions, semi-autonomous functions, and fully autonomous functions, as previously described.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-5, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. The systems, components and/or processes also can be embedded in a computer-readable storage, such as a computer program product or other data program storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. The phrase “computer-readable storage medium” means a non-transitory storage medium. A computer-readable storage medium may be, for example, an electronic, magnetic, optical, electromagnetic, infrared, or semiconductor system, apparatus, or device, or any suitable combination of the foregoing. A non-exhaustive list of the computer-readable storage medium can include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or a combination of the foregoing. In the context of this document, a computer-readable storage medium is, for example, a tangible medium that stores a program for use by or in connection with an instruction execution system or device.

Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through a network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A mapping system for improving estimation of lane lines along a roadway, comprising:
one or more processors;
a memory communicably coupled to the one or more processors and storing instructions that, when executed by the one or more processors, cause the one or more processors to:
acquire sensor data about the roadway, the sensor data including at least frames and associated point detections about a lane line associated with the roadway;
identify a selected point and nearby points of the point detections;
project lines from the nearby points to an orthogonal line extending from the selected point to define projection points;
estimate a line point of the lane line according to the projection points; and
generate an estimated line for the lane line using the line point and other line points.

2. The mapping system of claim 1, wherein the frames are discretized locations of a vehicle along the roadway, the point detections are machine-identified points of the lane line associated with perceptions when a vehicle is at separate ones of the frames.

3. The mapping system of claim 1, wherein the instructions to acquire the sensor data include instructions to assign a heading associated with a vehicle at respective ones of the frames to associated ones of the point detections, and
wherein the instructions to identify the selected point include instructions to project a cursor line from a prior line point a defined distance.

4. The mapping system of claim 1, wherein the instructions to project the lines include instructions to extend the orthogonal line from the selected point perpendicular to a heading associated with the selected point and projecting the lines from the nearby points to be perpendicular with the orthogonal line to define the projection points.

5. The mapping system of claim 1, wherein the instructions to estimate the line point include instructions to average the projection points along an axis of the orthogonal line.

6. The mapping system of claim 1, wherein the instructions to identify the nearby points include instructions to define a search radius around the selected point and locating the point detections within the search radius as the nearby points.

7. The mapping system of claim 1, wherein the instructions further include instructions to provide the estimated line as an approximation of the lane line, including generating a map of the roadway from the estimated line and controlling a vehicle using the map.

8. The mapping system of claim 1, wherein the mapping system is implemented within an autonomous vehicle to facilitate control of the autonomous vehicle along the roadway.

9. A non-transitory computer-readable medium including instructions that, when executed by one or more processors, cause the one or more processors to:
acquire sensor data about a roadway, the sensor data including at least frames and associated point detections about a lane line associated with the roadway;
identify a selected point and nearby points of the point detections;
project lines from the nearby points to an orthogonal line extending from the selected point to define projection points;
estimate a line point of the lane line according to the projection points; and
generate an estimated line for the lane line using the line point and other line points.

10. The non-transitory computer-readable medium of claim 9, wherein the frames are discretized locations of a vehicle along the roadway, the point detections are machine-identified points of the lane line associated with perceptions when a vehicle is at separate ones of the frames.

11. The non-transitory computer-readable medium of claim 9, wherein the instructions to acquire the sensor data include instructions to assign a heading associated with a vehicle at respective ones of the frames to associated ones of the point detections, and
wherein the instructions to identify the selected point include instructions to project a cursor line from a prior line point a defined distance.

12. The non-transitory computer-readable medium of claim 9, wherein the instructions to estimate the line point include instructions to average the projection points along an axis of the orthogonal line.

13. The non-transitory computer-readable medium of claim 9, wherein the instructions to project the lines include instructions to extend the orthogonal line from the selected point perpendicular to a heading associated with the selected point and projecting the lines from the nearby points to be perpendicular with the orthogonal line to define the projection points.

14. A method, comprising:
acquiring sensor data about a roadway, the sensor data including at least frames and associated point detections about a lane line associated with the roadway;
identifying a selected point and nearby points of the point detections;
projecting lines from the nearby points to an orthogonal line extending from the selected point to define projection points;
estimating a line point of the lane line according to the projection points; and
generating an estimated line for the lane line using the line point and other line points.

15. The method of claim 14, wherein the frames are discretized locations of a vehicle along the roadway, the point detections are machine-identified points of the lane line associated with perceptions when a vehicle is at separate ones of the frames.

16. The method of claim 14, wherein acquiring the sensor data includes assigning a heading associated with a vehicle at respective ones of the frames to associated ones of the point detections, and
wherein identifying the selected point includes projecting a cursor line from a prior line point a defined distance.

17. The method of claim 14, wherein projecting the lines includes extending the orthogonal line from the selected point perpendicular to a heading associated with the selected point and projecting the lines from the nearby points to be perpendicular with the orthogonal line to define the projection points.

18. The method of claim 14, wherein estimating the line point includes averaging the projection points along an axis of the orthogonal line.

19. The method of claim 14, wherein identifying the nearby points includes defining a search radius around the selected point and locating the point detections within the search radius as the nearby points.

20. The method of claim 14, further comprising:
providing the estimated line as an approximation of the lane line, including generating a map of the roadway from the estimated line and controlling a vehicle using the map.
